(19) United States
(12) Patent Application Publication
(10) Pub. No.: US 2023/0289929 A1
(43) Pub. Date: Sep. 14, 2023

(54) IMAGE DISPLAY SYSTEM, HEAD MOUNTED DISPLAY, AND IMAGE DISPLAY METHOD

(71) Applicant: Sony Interactive Entertainment Inc., Tokyo (JP)

(72) Inventors: Tetsugo Inada, San Mateo, CA (US); Akio Ohba, Tokyo (JP)

(73) Assignee: Sony Interactive Entertainment Inc., Tokyo (JP)

(21) Appl. No.: 18/041,916

(22) PCT Filed: Sep. 8, 2020
(86) PCT No.: PCT/JP2020/033858

§ 371 Date: Feb. 16, 2023

(51) Int. Cl. G06T 5/00; G09G 3/00

(52) U.S. Cl. CPC G06T 5/006; G09G 3/001; G09G 2360/12; G06T 2207/10024; G09G 2360/18; G09G 2320/0242

(57) ABSTRACT

An image generating apparatus directly draws, by using scene data, a distortion image generated by giving common distortion to primary colors of R, G, and B, and transmits the distortion image to a head mounted display in an order of drawn pixel sequences. The head mounted display acquires color information from positions different for each of R, G, and B and dependent on chromatic aberration of an ocular lens in partial data of the distortion image stored in a line buffer. In this manner, the image generating apparatus generates partial data, each having different distortion, for R, G, and B, respectively, and immediately outputs the generated partial data to a display panel.

### TECHNICAL FIELD

The present invention relates to an image display system, a head mounted display, and an image display method for displaying an image appreciated via an ocular lens.

### BACKGROUND ART

An image display system has been widespread as a system available for appreciation of a target space from a free viewpoint. For example, there has been known electronic content which achieves VR (virtual reality) by designating a virtual three-dimensional space as a display target, and displaying an image corresponding to a visual line direction of a user wearing a head mounted display. Use of the head mounted display can increase a sense of immersion into a picture, and improve operability of an application such as a game. Moreover, there has been developed a walk-through system where a user wearing a head mounted display physically moves to virtually walk around a space displayed as a picture.

### SUMMARY

### Technical Problem

In a case where a change of a visual field or movement of a displayed world continues, high responsiveness of image display is required regardless of a display device type and a degree of freedom of a viewpoint. Meanwhile, for achieving more realistic image expression, higher resolution or complicated calculation is required, for example. In this case, an image processing load increases. Accordingly, display may not catch up with movement of the visual field or the displayed world and cause deterioration of a sense of realism or visually induced motion sickness.

The present invention has been developed in consideration of the abovementioned problem. An object of the present invention is to provide a technology capable of achieving both responsiveness and quality of image display.

### Solution to Problem

An aspect of the present invention relates to an image display system. This image display system displays a distortion image generated by giving, to a source image corresponding to a display target, a change opposite to a change produced by aberration of an ocular lens to allow appreciation via the ocular lens, and is characterized by including an image generating apparatus that draws a distortion image having common distortion regardless of primary colors, and a display device that determines pixel values on the basis of sampling results obtained from different positions of the distortion image for each of the primary colors in accordance with chromatic aberration of the ocular lens and outputs the determined pixel values to a display panel.

Another aspect of the present invention relates to a head mounted display. This head mounted display displays a distortion image generated by giving, to a source image corresponding to a display target, a change opposite to a change produced by aberration of an ocular lens to allow appreciation via the ocular lens, and is characterized by including an image data acquisition unit that acquires data of a distortion image having common distortion regardless of primary colors, and a display unit that determines pixel values on the basis of sampling results obtained from different positions of the distortion image for each of the primary colors in accordance with chromatic aberration of the ocular lens and outputs the determined pixel values to a display panel.

A further aspect of the present invention relates to an image display method. This image display method is performed by an image display system that displays a distortion image generated by giving, to a source image corresponding to a display target, a change opposite to a change produced by aberration of an ocular lens to allow appreciation via the ocular lens. The image display method is characterized by including a step of drawing a distortion image having common distortion regardless of primary colors, and a step of determining pixel values on the basis of sampling results obtained from different positions of the distortion image for each of the primary colors in accordance with chromatic aberration of the ocular lens and outputting the determined pixel values to a display panel.

Note that any combinations of the constituent elements described above, and expression conversions made for methods, devices, systems, computer programs, data structures, recording media, or the like in the present invention are also valid aspects of the present invention.

### Advantageous Effect of Invention

According to the present invention, both responsiveness and quality of image display are achievable.

### BRIEF DESCRIPTION OF DRAWINGS

FIG. 1 is a diagram depicting an external appearance example of a head mounted display according to the present embodiment.

FIG. 2 is a diagram depicting a configuration example of an image processing system according to the present embodiment.

FIG. 3 is a diagram for explaining an example of an image world caused to be displayed on the head mounted display by an image generating apparatus according to the present embodiment.

FIG. 4 is a diagram depicting a general transition of an image until display on the head mounted display in the mode depicted in FIG. 3.

FIG. 5 is a diagram for explaining color drift caused in a distortion image according to the present embodiment.

FIG. 6 is a diagram depicting a general processing procedure for displaying a distortion image generated in consideration of chromatic aberration of an ocular lens.

FIG. 7 is a diagram depicting another processing procedure for displaying the distortion image generated in consideration of the chromatic aberration of the ocular lens.

FIG. 8 is a diagram depicting a processing procedure for displaying the distortion image generated in consideration of the chromatic aberration of the ocular lens according to the present embodiment.

FIG. 9 is a diagram depicting an internal circuit configuration of the image generating apparatus according to the present embodiment.

FIG. 10 is a diagram depicting an example of an internal configuration of the head mounted display according to the present embodiment.

FIG. 11 is a diagram depicting a configuration of function blocks associated with the image generating apparatus and the head mounted display according to the present embodiment.

FIG. 12 is a diagram for explaining a method performed by a distortion image generating unit to determine pixel values of a distortion image according to the present embodiment.

FIG. 13 is a diagram for explaining a pixel value sampling process performed by the head mounted display according to the present embodiment.

### DESCRIPTION OF EMBODIMENT

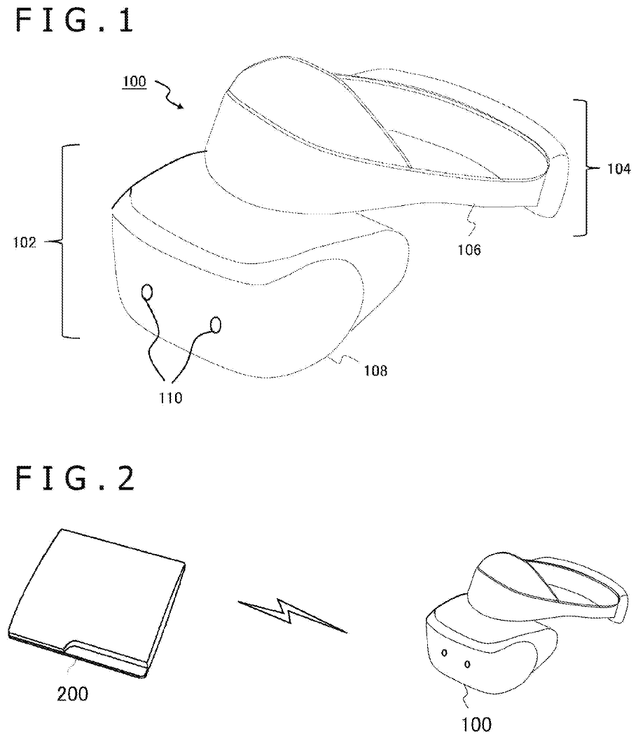

It is assumed, in the present embodiment, that a user appreciates an image displayed on a display panel via an ocular lens. A device which displays the image in this particular condition is not limited to any specific type. A head mounted display will be hereinafter presented as an example of this display device. FIG. 1 depicts an external appearance example of a head mounted display 100. The head mounted display 100 in this example includes an output mechanism unit 102 and an attachment mechanism unit 104. The attachment mechanism unit 104 includes an attachment band 106 which is worn around the head of the user and achieves fixation of the device when worn by the user.

The output mechanism unit 102 includes a housing 108 having a shape to cover the left and right eyes of the user in a state where the head mounted display 100 is attached to the user. A display panel is provided inside the housing 108 in such a position as to face the eyes at the time of attachment. An ocular lens is further provided inside the housing 108 as a lens positioned between the display panel and the eyes of the user at the time of attachment of the head mounted display 100, to expand a viewing angle of the user. Moreover, the head mounted display 100 may further include speakers and earphones disposed at positions corresponding to the ears of the user at the time of attachment. Furthermore, the head mounted display 100 includes a built-in motion sensor to detect translational motion and rotational motion of the head of the user wearing the head mounted display 100 and also a position and a posture of the head at each time.

The head mounted display 100 in this example includes stereo cameras 110 in front of the housing 108 to capture a moving image of a surrounding actual space in a visual field corresponding to a visual line of the user. If the captured image is displayed immediately, what is called video see-through, which allows the user to view a state of the actual space in a facing direction of the user without a change and a pause, is achievable. In addition, if a virtual object is drawn on an image of a real object included in the captured image, AR (augmented reality) is achievable.

FIG. 2 depicts a configuration example of an image processing system according to the present embodiment. The head mounted display 100 is connected to an image generating apparatus 200 by wireless communication or an interface which connects a peripheral device such as a USB (universal serial bus). The image generating apparatus 200 may be further connected to a server via a network. In this case, the server may provide, for the image generating apparatus 200, an online application such as a game in which a plurality of users are allowed to participate via the network.

The image generating apparatus 200 identifies a viewpoint position or a visual line direction of the user wearing the head mounted display 100 on the basis of a position or a posture of the head of the user, generates a display image in a visual field corresponding to the identified position or direction, and outputs the generated display image to the head mounted display 100. The purpose of image display in this particular condition may be any of various purposes. For example, the image generating apparatus 200 may generate, as the display image, an image of a virtual world corresponding to a stage of an electronic game while advancing the game, or may display a still image or a moving image for appreciation or information offering regardless of whether or not a virtual world is a real world. If a panorama image is displayed at a large angle of view around the center located at the viewpoint of the user, a sense of immersion into a displayed world can be given to the user.

Note that a part or all of functions of the image generating apparatus 200 may be provided inside the head mounted display 100. In a case where all of the functions of the image generating apparatus 200 are built in the head mounted display 100, the image processing system depicted in the figure is achieved by only the one head mounted display 100.

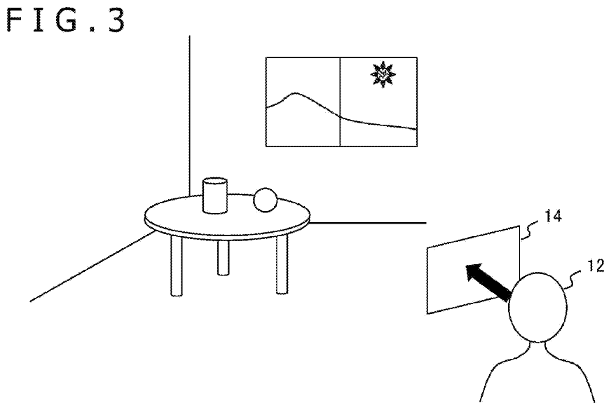

FIG. 3 is a diagram for explaining an example of an image world caused to be displayed on the head mounted display 100 by the image generating apparatus 200 according to the present embodiment. Created in this example is a state where a user 12 exists in a room corresponding to a virtual space. As depicted in the figure, objects such as a wall, a floor, a window, a table, and stuff on the table are disposed in a world coordinate system defining the virtual space. The image generating apparatus 200 defines a view screen 14 in this world coordinate system in accordance with a viewpoint position and a visual line direction of the user 12, and presents images of the objects in the view screen 14 to draw a display image.

If a position and a direction of the view screen 14 are changed in accordance with the viewpoint position and the visual line direction of the user 12 (these position and direction will be hereinafter collectively referred to as a “viewpoint” in some cases) acquired at a predetermined rate, an image can be displayed in a visual field corresponding to the viewpoint of the user. If a stereo image having disparity is generated and displayed in each of left and right regions of a display panel, the virtual space can also be presented as a stereoscopic vision. In this manner, the user 12 can enjoy a virtual-reality experience as if he or she is present in the room of the displayed world.

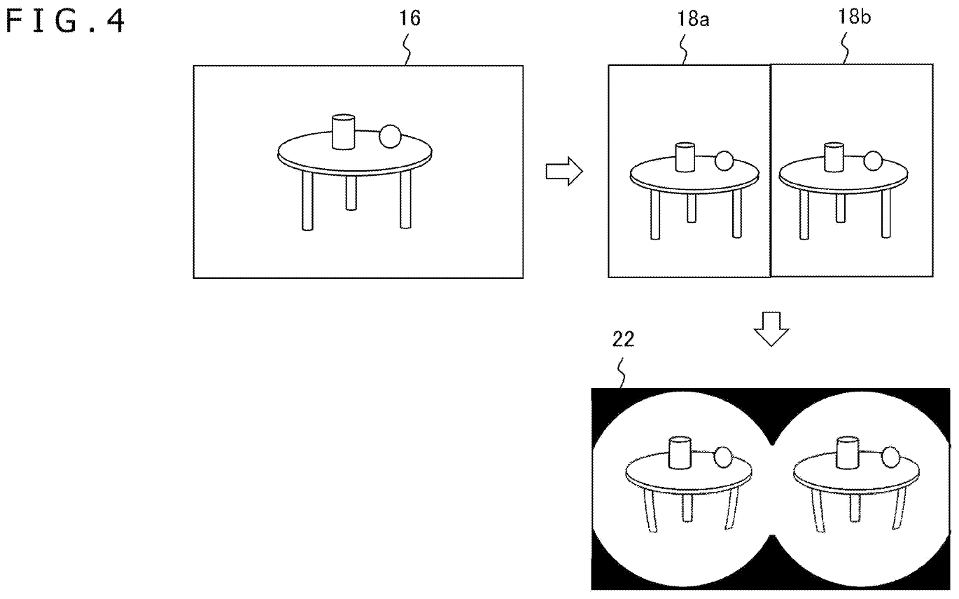

FIG. 4 depicts a general transition of an image until display on the head mounted display 100 in the mode depicted in FIG. 3. Initially, an image 16 corresponding to the visual field of the user is generated by projecting the objects present in the virtual world on the view screen corresponding to the viewpoint of the user. In a case of a stereoscopic view, a stereo image including a left-eye image 18a and a right-eye image 18b is generated by shifting images included in the image 16 in a lateral direction by a disparity corresponding to a distance between the left and right eyes, or generating the image 16 for each of the eyes.

Thereafter, inversion correction is applied to each of the left-eye image 18a and the right-eye image 18b in accordance with distortion aberration or chromatic aberration produced by the ocular lens to generate a display image 22 as a final image. The inverse correction here refers to a process for distorting the image in advance or shifting pixels for each of primary colors (R, G, B) by giving an inverse change from a change produced by the aberration of the lens to allow the original image 16 to become visually recognizable when viewed via the ocular lens. For example, in a case of a lens which presents a view of an image having four sides concaved in a spool shape, the image is curved into a barrel shape as depicted in the figure. The image given distortion or color drift corresponding to the ocular lens will be hereinafter referred to as a “distortion image.”

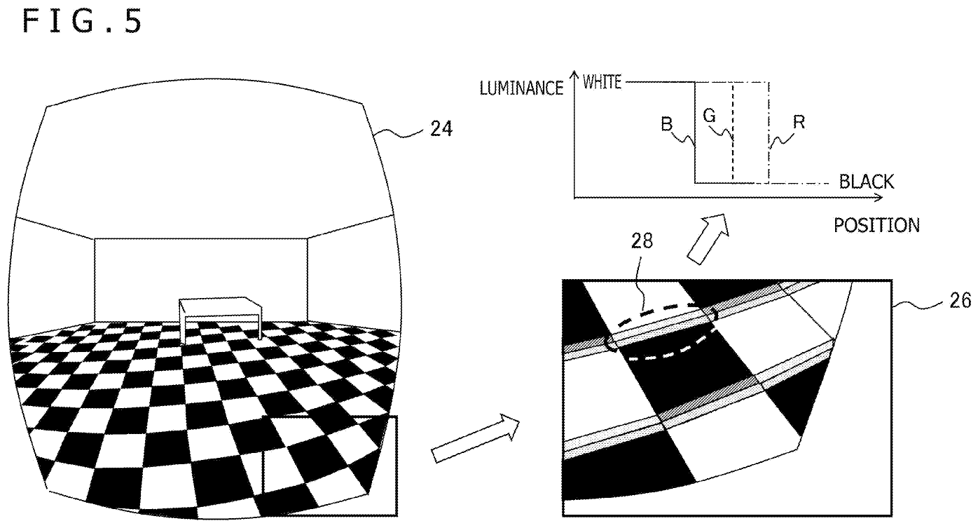

FIG. 5 is a diagram for explaining color drift caused in a distortion image. In this example, a distortion image 24 represents a room interior which includes a floor having a white and block checkered pattern. As depicted in the figure, the distortion image 24 is given a larger degree of distortion as going toward a peripheral portion on the basis of characteristics of the ocular lens. Distortion is given in a manner different for each of primary colors of R (red), G (green), and B (blue) in accordance with chromatic aberration of the ocular lens. As a result, color drift caused in the distortion image 24 increases as going toward the peripheral portion. For example, as depicted in an image 26 corresponding to an enlarged area located in a lower right part of the distortion image 24, a color at a portion 28, where a boundary between white and black is originally indicated, gradually changes.

Specifically, as presented in an upper part of the figure, in a state where the boundary of switching from white to black differs for each of R, G, and B, a color other than white and black is produced, such as a case where red having maximum luminance remains at a portion which should originally correspond to an area designated as black. By viewing the distortion image 24 containing this color drift via the ocular lens, the change of the color is corrected to an appropriate position by chromatic aberration to allow visual recognition of an image containing no color drift. For example, the distortion image 24 can be generated by temporarily generating an image having no distortion and distorting the image by a degree different for each aberration of the primary colors.

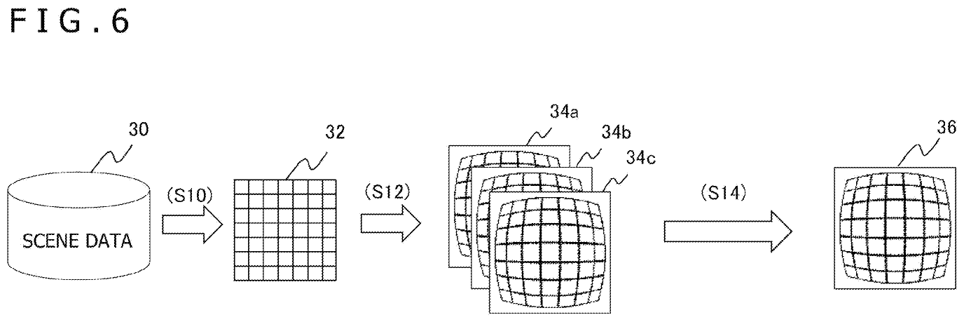

FIG. 6 depicts a general processing procedure for displaying a distortion image generated in consideration of chromatic aberration of the ocular lens. Initially, the image generating apparatus generates an image 32 having no distortion, by projecting scene data 30 such as three-dimensional information representing the virtual world on the view screen (S10), for example. This image corresponds to the image 16 in FIG. 4, and is equivalent to an ordinary image where respective pixels have pixel values of R, G, and B without deviation. Subsequently, the image generating apparatus distorts the image by a degree different for each chromatic aberration of three planes of R, G, and B (S12).

In this manner, distortion images 34a, 34b, and 34c corresponding to R, G, and B, respectively, and each having slight deviation in the image are generated. An image having these distortion images as elements of pixel values is output to the display panel as a display image 36 (S14). In this manner, an image having color drift such as the distortion image 24 in FIG. 5 is displayed. If the image processing system depicted in FIG. 2 is employed, the image generating apparatus 200 of this system generates the distortion images 34a, 34b, and 34c for R, G, and B, and transmits these images as data of a display image. In this manner, the head mounted display 100 is allowed to display the transmitted data without a necessity of change.

However, these processing procedures require processes for initially storing the image 32 having no distortion in a frame buffer, reading values of respective colors from the image 32, and then deforming the image 32 into the distortion images 34a, 34b, and 34c. Accordingly, one frame or more of a storage area offered for the buffer needs to be secured. In addition, a necessity of a sufficient time for memory access increases a delay produced until output to the head mounted display 100.

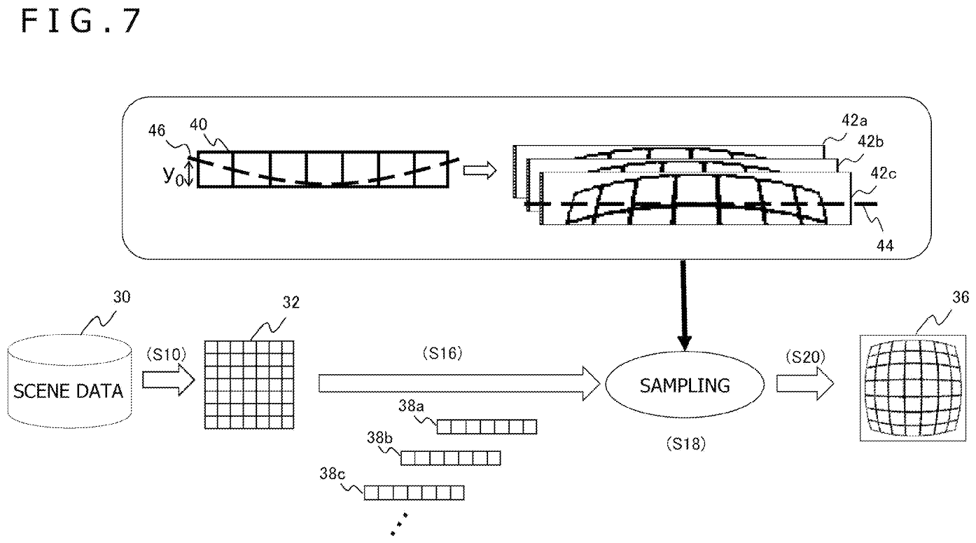

FIG. 7 depicts another processing procedure for displaying the distortion image generated in consideration of the chromatic aberration of the ocular lens. In this case, the image generating apparatus similarly generates the image 32 having no distortion, by projecting the scene data 30 on the view screen (S10), for example. Meanwhile, the image generating apparatus 200 in this example transmits the data of the image 32 having no distortion to the head mounted display without change, and the head mounted display gives distortion corresponding to distortion aberration and chromatic aberration to the data.

Specifically, the image generating apparatus transmits the data of the image 32 having no distortion to the head mounted display in an order of drawn pixel sequences (S16). The figure expresses transmission of the pixel sequences with time differences by illustrating partial data 38a, 38b, 38c, and others with shifts. The head mounted display 100 stores the transmitted data of the pixel sequences in a line buffer, and then samples the data from positions designated in consideration of the distortion aberration and the chromatic aberration to determine pixel values of the display image 36 and display the display image 36 on the display panel (S18 and S20).

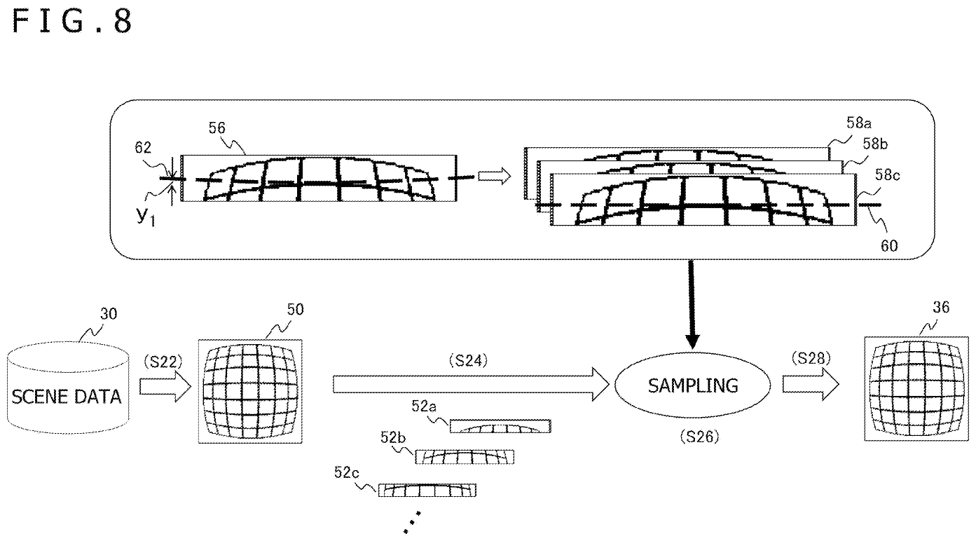

In the sampling process, the head mounted display acquires color information from positions different for each of R, G, and B and dependent on the chromatic aberration from partial data 40 of the image having no distortion and stored in the line buffer as depicted in an upper part of the figure. In this manner, partial data 42a, 42b, and 42c each having different distortion, for R, G, and B, respectively, are generated and displayed. While each of the partial data 40, 42a, 42b, and 42c is represented by a width of a grid unit in the image in the figure, these data can be updated or output in pixel line units in an actual situation. This also applies to FIG. 8 to be described later.

In such a manner, a buffer memory for storing one frame of intermediate data and a process for accessing the memory can be eliminated from the image generating apparatus in comparison with the procedure depicted in FIG. 6. Meanwhile, all data of a sampling destination region needs to be retained in the line buffer so as to give distortion for each color and output the data by the head mounted display 100. For example, in order to output a pixel sequence 44 of the display image having distortion, data of a sampling destination 46 of an image having no distortion is needed. As depicted in the figure, a line connecting the sampling destination 46 is curved in accordance with given distortion. Accordingly, y₀ lines of pixel sequences are needed as data to output one line of the display image.

According to the characteristics of the lens, the necessary number of lines increases as going toward an upper end or a lower end of the image, and can also vary for each of R, G, and B. Accordingly, a line buffer capable of storing a necessary maximum number of lines needs to be prepared. In this case, a memory cost inside the head mounted display 100 increase. Moreover, a processing time associated with readout also increases. This increase produces a delay until display of image data after reception of the image data. According to the present embodiment, therefore, the image generating apparatus 200 gives the same distortion to all the three planes of R, G, and B, and thereafter, the head mounted display 100 gives only remaining distortion.

FIG. 8 depicts a processing procedure for displaying the distortion image generated in consideration of the chromatic aberration of the ocular lens according to the present embodiment. In this example, the image generating apparatus 200 generates a distortion image 50 directly from the scene data 30 as an image to which distortion common to R, G, and B is given. For example, the image generating apparatus 200 generates the distortion image 50 generated by giving distortion, which should be given to the plane of G included in R, G, and B, to all the planes. Thereafter, the image generating apparatus 200 transmits data of the distortion image 50 to the head mounted display in an order of drawn pixel sequences (S24).

The direct drawing of the distortion image 50 eliminates the necessity of providing the frame buffer for temporarily storing the image having no distortion. Moreover, the delay time produced until image output after image drawing can be reduced by giving the same distortion to all the planes and then outputting the images in the order of drawing. The figure expresses transmission of the pixel sequences with time differences by illustrating partial data 52a, 52b, 52c, and others with shifts. However, this transmission in an actual situation may be achieved in pixel sequence units.

The head mounted display 100 stores the transmitted data of the pixel sequences in the line buffer, and then samples the data from the line buffer to determine pixel values of the display image 36 and display the display image 36 on the display panel (S26 and S28). Similarly to the procedure of FIG. 7, the head mounted display 100 in the sampling process acquires color information from positions different for each of R, G, and B and dependent on the chromatic aberration in partial data 56 stored in the line buffer as depicted in an upper part of the figure. In this manner, partial data 58a, 58b, and 58c each having different distortion, for R, G, and B, respectively, are generated and displayed.

Meanwhile, according to the present embodiment, the image to which distortion has been already given is stored in the line buffer. Accordingly, the differences between the pixel sequences of the display image and the positions of the sampling destinations considerably decrease in comparison with the case of FIG. 7. For example, in a case where the image generating apparatus 200 gives distortion corresponding to G, the head mounted display 100 is only required to acquire pixel values at the same positions in the line buffer for the G plane, and output the acquired pixel values without change. For the R and B planes, the head mounted display 100 is only required to acquire color information indicating destinations displaced by differences from the distortion of G. For example, in a case where a pixel sequence 60 of the display image is to be output in the figure, data of a sampling destination 62 in the original distortion image is needed. However, the sampling destination 62 is distributed almost linearly, and therefore, pixel sequences to be needed corresponding to y₁ lines obviously decrease in comparison with those of the case in FIG. 7.

As a result, a memory capacity required to be secured for the entire system, such as the frame buffer of the image generating apparatus 200 and the line buffer of the head mounted display 10, can be reduced. Moreover, the time required for memory access can be shortened, and therefore, the delay produced until image display after image drawing can be reduced by a synergistic effect of the foregoing effect and simplification of image generation achieved by stages performed within the image generating apparatus 200. Note that the common distortion given to the image brains of R, G, and B by the image generating apparatus 200 may be distortion corresponding to R or B, or other predetermined distortion. However, giving distortion of any one of R, G, and B is advantageous in a point that the head mounted display 100 is allowed to output pixel values of the color corresponding to the given distortion without change.

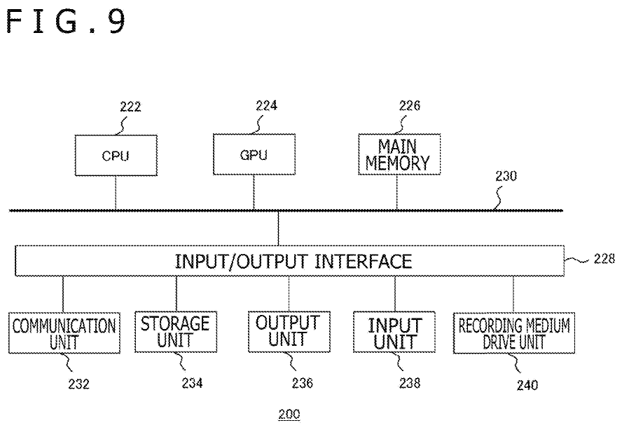

FIG. 9 depicts an internal circuit configuration of the image generating apparatus 200. The image generating apparatus 200 includes a CPU (central processing unit) 222, a GPU (graphics processing unit) 224, and a main memory 226. The respective units thus provided are connected to each other via a bus 230. An input/output interface 228 is further connected to the bus 230.

Connected to the input/output interface 228 are a peripheral device interface such as a USB and an IEEE (Institute of Electrical and Electronics Engineers) 1394 interface, a communication unit 232 including a network interface such as a wired or wireless LAN (local area network), a storage unit 234 such as a hard disk drive and a non-volatile memory, an output unit 236 which outputs data to the head mounted display 100, an input unit 238 which receives input of data from the head mounted display 100, and a recording medium drive unit 240 which drives a removable recording medium such as a magnetic disk, an optical disk, and a semiconductor memory.

The CPU 222 controls the entire image generating apparatus 200 by executing an operating system stored in the storage unit 234. The CPU 222 also executes various programs read from the removable recording medium and loaded to the main memory 226, or downloaded via the communication unit 232. The GPU 224 has a function of a geometry engine and a function of a rendering processor, and is configured to perform a drawing process in accordance with a drawing command issued from the CPU 222 and output the process result to the output unit 236. The main memory 226 includes a RAM (random access memory), and stores programs and data necessary for processing.

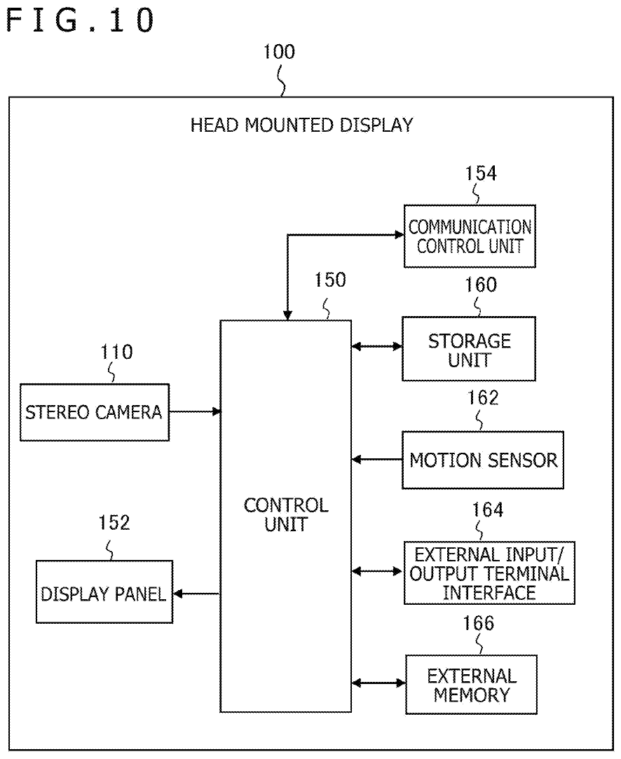

FIG. 10 depicts an example of an internal configuration of the head mounted display 100. A control unit 150 is a main processor which processes signals such as image signals and sensor signals, commands, and data, and outputs the processed signals, commands, and data. The stereo camera 110 supplies data of a captured image to the control unit 150 at a predetermined rate. A display panel 152 includes a light emitting panel such as a liquid crystal panel and an organic EL (electroluminescent) panel, and a control mechanism for the light emitting panel, and receives and displays image signals transmitted from the control unit 150.

A communication control unit 154 transmits data input from the control unit 150 to the outside by wired or wireless communication via a network adapter or an antenna, both not depicted. The communication control unit 154 also receives data from the outside by wired or wireless communication via the network adapter or the antenna, and outputs the data to the control unit 150. A storage unit 160 temporarily stores data, parameters, operation signals, and the like processed by the control unit 150.

A motion sensor 162 measures posture information such as a rotation angle and an inclination of the head mounted display 100, and sequentially supplies the posture information to the control unit 150. An external input/output terminal interface 164 is an interface for connecting a peripheral device such as a USB controller. An external memory 166 is an external memory such as a flash memory. The control unit 150 is capable of outputting images and audio data to the display panel 152 and not-depicted earphones and speakers to cause these components to output the images and the audio data, and supplying images and audio data to the communication control unit 154 to cause the communication control unit 154 to transmit the images and the audio data to the outside.

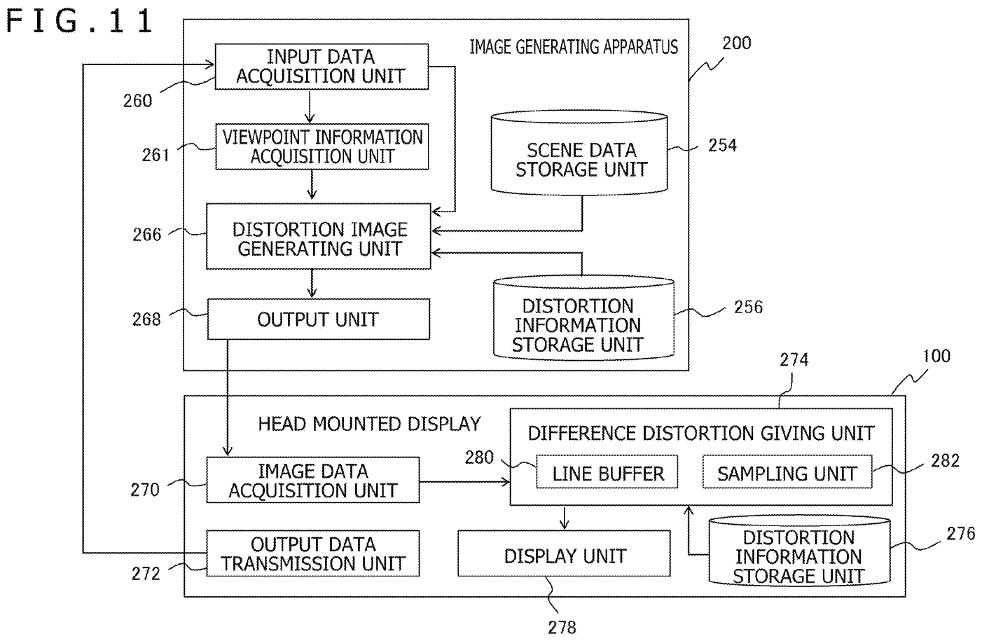

FIG. 11 depicts configurations of function blocks associated with the image generating apparatus 200 and the head mounted display 100 according to the present embodiment. As described above, the image generating apparatus 200 is allowed to perform ordinary information processing such as advancing an electronic game and communicating with a server. However, FIG. 11 depicts the image generating apparatus 200 while paying particular attention to a function for generating a display image. Note that at least a part of the functions of the image generating apparatus 200 depicted in FIG. 11 may be incorporated in the head mounted display 100. Alternatively, at least a part of the functions of the image generating apparatus 200 may be incorporated in a server connected to the image generating apparatus 200 via a network.

Moreover, the function blocks depicted in FIG. 11 are achievable by the configuration including the CPU, the GPU, the control unit, the various memories, sensors, and the like depicted in FIG. 9 or 10 in terms of hardware, or by a program exerting various functions loaded from a recording medium or the like to a memory, such as a data input function, a data retaining function, an image processing function, and a communication function, in terms of software. Accordingly, it is understood by those skilled in the art that these function blocks are achievable in various forms by using only hardware, only software, or a combination of hardware and software. These function blocks are therefore not limited to any particular form.

The image generating apparatus 200 includes an input data acquisition unit 260 which acquires data transmitted from the head mounted display 100, a viewpoint information acquisition unit 261 which acquires information associated with a viewpoint of the user, a distortion image generating unit 266 which generates a distortion image representing a display target space, and an output unit 268 which outputs data of a distortion image to the head mounted display 100. The image generating apparatus 200 further includes a scene data storage unit 254 which stores display target scene data, and a distortion information storage unit 256 which stores information indicating distortion to be given by the image generating apparatus 200.

The input data acquisition unit 260 includes the input unit 238, the CPU 222, and the like depicted in FIG. 9, and acquires measurement values obtained by the motion sensor and transmitted from the head mounted display 100, and data such as images captured by the stereo camera 110 at a predetermined rate. The viewpoint information acquisition unit 261 includes the CPU 222 and the like depicted in FIG. 9, and acquires a viewpoint position and a visual line direction of the user at a predetermined rate. For example, the viewpoint information acquisition unit 261 identifies a position or a posture of the head portion on the basis of a measurement value of the motion sensor of the head mounted display 100. A not-depicted light emitting marker may be provided outside the head mounted display 100, and the viewpoint information acquisition unit 261 may acquire and analyze a captured image of the light emitting marker from a not-depicted imaging device and may obtain information associated with the position and the posture of the head portion on the basis of the captured image.

Alternatively, the viewpoint information acquisition unit 261 may acquire the position or the posture of the head portion by using SLAM (simultaneous localization and mapping) or other technologies on the basis of the image captured by the stereo camera 110. If the position or the posture of the head portion is acquirable in such a manner, an approximate viewpoint position and an appropriate visual line direction of the user can be identified. Note that the viewpoint information acquisition unit 261 may predict the viewpoint position and the visual line direction at the timing of image display on the head mounted display 100 on the basis of movements of previous viewpoints. It is understood by those skilled in the art that other various methods may be used as the method for acquiring or predicting information associated with the viewpoint of the user.

The distortion image generating unit 266 includes the GPU 224, the main memory 226, and the like depicted in FIG. 6, and draws, at a predetermined rate, an image representing a display target space in a visual field corresponding to a viewpoint or a visual line acquired or predicted by the viewpoint information acquisition unit 261. This image may be a result of execution of information processing such as a game. The scene data storage unit 254 stores information associated with data of an object model necessary for image drawing, and progress in scenes. As described above, the distortion image generating unit 266 directly draws an image having distortion common to R, G, and B by using data stored in the scene data storage unit 254, data of a captured image transmitted from the head mounted display 100 as necessary, or the like.

The method used by the distortion image generating unit 266 for image drawing is not particularly limited, but may be any method such as ray tracing and rasterization. The distortion information storage unit 256 stores information associated with distortion given by the distortion image generating unit 266 to an image. For example, the distortion information storage unit 256 stores a displacement vector map which indicates a correlation between respective pixels in a plane of a distortion image and positions in a plane of an image having no distortion. On the basis of this map, the distortion image generating unit 266 acquires a color of an image to be expressed at a corresponding position in the image having no distortion, by ray tracing or other methods for each of the pixels in the plane of the distortion image, and designates the acquired color as a pixel value of the original pixel.

The “image having no distortion” here is not actually generated, but is obtained by using only position coordinates of a corresponding point as a medium for acquiring color information with use of a conventional method. Specifically, the distortion image generating unit 266 directly acquires color information associated with the corresponding point to determine a pixel value of the distortion image. As described above, the distortion image generating unit 266 gives common distortion to each of R, G, and B. Accordingly, the distortion information storage unit 256 stores one type of data representing distortion, such as a displacement vector map. For example, the information storage unit 256 stores data representing distortion for G.

For presenting a stereoscopic view of the display image, the distortion image generating unit 266 generates a distortion image for each of the left eye and the right eye. Specifically, the distortion image generating unit 266 generates a distortion image assuming that the left eye is designated as a viewpoint and that a left-eye ocular lens is used, and a distortion image assuming that the right eye is designated as a viewpoint and that a right-eye ocular lens is used. The output unit 268 includes the CPU 222, the main memory 226, the output unit 236, and others depicted in FIG. 6, and sequentially transmits data of a distortion image generated by the distortion image generating unit 266 to the head mounted display 100. At this time, data of pixel values determined by the distortion image generating unit 266 in a predetermined order of pixel sequences may be immediately output in this order from the output unit 268. In the case of the stereoscopic view, the data to be output is data containing a left-eye distortion image disposed in a left half of the image, and a right-eye distortion image disposed in a right half of the image.

The head mounted display 100 includes an output data transmission unit 272 which transmits various kinds of data to the image generating apparatus 200 as data for generating a display image, an image data acquisition unit 270 which acquires data of a distortion image transmitted from the image generating apparatus 200, a difference distortion giving unit 274 which gives further necessary distortion to the transmitted distortion image, a distortion information storage unit 276 which stores information associated with distortion to be given by the head mounted display 100, and a display unit 278 which displays a final distortion image.

The output data transmission unit 272 includes the stereo camera 110, the motion sensor 162, the communication control unit 154, and others depicted in FIG. 10, and transmits data necessary for generating a display image, such as an image captured by the stereo camera 110 and a measurement value obtained by the motion sensor 162, to the image generating apparatus 200 at a predetermined rate. The image data acquisition unit 270 includes the communication control unit 154, the control unit 150, and others depicted in FIG. 10, and acquires data of a distortion image transmitted from the image generating apparatus 200. At this time, the image data acquisition unit 270 sequentially acquires data of pixel values sent by the image generating apparatus 200 in an order of rasterization or the like, and supplies the data to the difference distortion giving unit 274.

The difference distortion giving unit 274 includes the control unit 150, the storage unit 160, and others depicted in FIG. 10, and gives, as necessary, remaining distortion to a distortion image transmitted from the image generating apparatus 200. Specifically, the difference distortion giving unit 274 includes a line buffer 280 which temporarily stores data of the distortion image transmitted from the image generating apparatus 200 in pixel sequence units, and a sampling unit 282 which samples data stored in the line buffer 280 and determines pixel values in an order of pixels or pixel sequences to be output to the display panel. In a case where distortion for G is given to an original image, a sampling destination of a component of G at the time of display of a pixel sequence in one line is a pixel sequence in one line at the same position. Each sampling destination of components of R and B is distributed in a shape curved to some extent to reflect a difference from the distortion for G.

At this time, the sampling unit 282 determines color information by interpolating values of a plurality of pixels positioned around the sampling destination, and designates the determined color information as pixel values of R and B of the display image. The distortion information storage unit 276 stores information associated with distortion to be given to the image by the difference distortion giving unit 274. Specifically, the distortion information storage unit 276 stores information associated with differences between distortion given by the image generating apparatus 200 and distortion to be originally given to respective planes of R, G, and B.

For example, it is assumed that the information associated with the distortion is a difference vector map indicating a correlation between respective pixels in a plane of a final display image and corresponding positions in the distortion image transmitted from the image generating apparatus 200. In this manner, the sampling unit 282 acquires color information from appropriate positions for each of R, G, and B on the basis of a correlation between a line to be output to the display unit 278 and a line stored in the line buffer 280. The line buffer 280 stores data of the sufficient number of lines of the distortion image for covering a maximum amount of deviation from the output target line to the sampling position.

The display unit 278 includes the control unit 150, the display panel 152, and others depicted in FIG. 10, and causes light emission from corresponding elements with luminance corresponding to pixel values of R, G, and B acquired by the difference distortion giving unit 274 to display a final distortion image. In this case, the difference distortion giving unit 274 sequentially determines pixel values for lines to be output to the display panel by sampling, and the display unit 278 starts output of the corresponding lines in response to the determination of the pixel values. In this manner, steps from sampling to display are achievable only with a low delay.

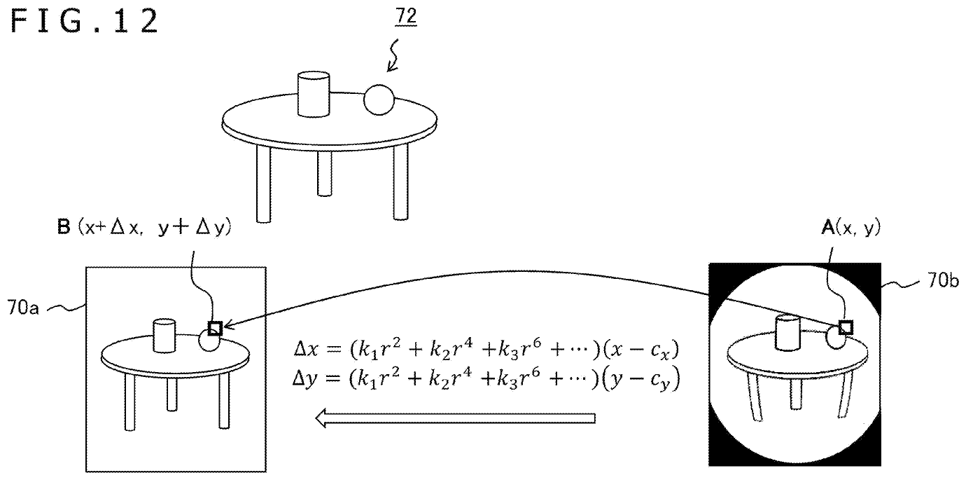

FIG. 12 is a diagram for explaining a method performed by the distortion image generating unit 266 to determine pixel values of a distortion image. As depicted in a left part of the figure, in a case of an ordinary image 70a, pixel values are determined by projecting an object 72 as a display target on a view screen or calculating a color of the object 72 at which light beams generated from a viewpoint arrive. According to the present embodiment, however, a distortion image 70b is directly drawn such that the image 70a is visually recognizable via the ocular lens.

Specifically, the distortion image generating unit 266 calculates a position to which a target pixel A of the distortion image 70b is displaced when viewed via the lens, and designates color information associated with a pixel B corresponding to the displacement destination as a pixel value of the target pixel A. A relation between the distortion image 70b drawn in this manner and the image 70a having no distortion is equivalent to a relation between a captured image having distortion produced by a lens of an ordinary camera and an image after distortion correction. Accordingly, a displacement vector (Δx, Δy) for a target pixel at position coordinates (x, y) can be calculated by the following general expression.

Δx=(k₁r²+k₂r⁴+k₃r⁶+ . . . )(x−cₓ) (Equation 1)

Δy=(k₁r²+k₂r⁴+k₃r⁶+ . . . )(y−c_{y}) [Math. 1]

In this expression, r indicates a distance from an optical axis of the lens to a target pixel, and (Cx, Cy) indicates a position of the optical axis of the lens. In addition, k₁, k₂, k₃, and others are lens distortion coefficients and are dependent on design of the lens and a wavelength band of light. A degree of correction is not limited to a particular degree. The distortion image generating unit 266 obtains a pixel value of the pixel B at position coordinates (x+Δx, y+Δy) corresponding to the displacement destination by using an ordinary method with reference to a displacement vector (Δx, Δy) calculated for position coordinates (x, y) of the target pixel A by using Equation 1, and designates the obtained pixel value as the pixel value of the target pixel A. For example, the pixel value of the pixel B and the pixel value of the pixel A are determined by emitting light beams which pass through the pixel B from a viewpoint and deriving a color at an arrival point on the object 72.

As described above, a displacement vector map which establishes a correlation between the displacement vector (Δx, Δy) and each pixel in the plane of the distortion image is created beforehand and stored in the distortion information storage unit 256. In this manner, the distortion image generating unit 266 is allowed to determine pixel values of the distortion image in a predetermined order such as an order of rasterization. While Equation 1 is a typical equation for correcting distortion produced by an ocular lens, it is not intended that calculation of distortion carried out in the present embodiment is limited to this calculation. Moreover, a format of distortion information stored in the distortion information storage unit 256 is not limited to a particular format.

The difference distortion giving unit 274 of the head mounted display 100 acquires color information from positions each deviated by a difference vector obtained by subtracting, from an original displacement vector for corresponding one of R, G, and B, a displacement vector used by the image generating apparatus 200 to give distortion. For example, the original displacement vectors for R, G, and B here are values obtained by substituting respective lens distortion coefficients of R, G, and B for Equation 1.

Assuming that the displacement vector used by the image generating apparatus 200 for the pixel at the position coordinates (x, y) is DO (x, y) and that the original displacement vectors for R, G, and B are DR (x, y), DG (x, y), and DB (x, y), difference vectors ΔR (x, y), ΔG (x, y), and ΔB (x, y) for R, G, and B are represented in the following manner.

ΔR(x,y)=DR(x,y)−DO(x,y)

ΔG(x,y)=DG(x,y)−DO(x,y)

ΔB(x,y)=DB(x,y)−DO(x,y)

For example, in a case where the image generating apparatus 200 gives distortion corresponding to G, DO (x, y)=DG (x, y) holds. Accordingly, difference vectors for the respective colors are represented in the following manner.

ΔR(x,y)=DR(x,y)−DG(x,y)

ΔG(x,y)=0

ΔB(x,y)=DB(x,y)−DG(x,y)

The distortion information storage unit 276 of the head mounted display 100 stores, in advance, a difference vector map which establishes a correlation between the difference vectors described above and respective pixels of the display image. In this manner, the difference distortion giving unit 274 is allowed to sample color information associated with positions corresponding to display target pixels from the line buffer appropriately.

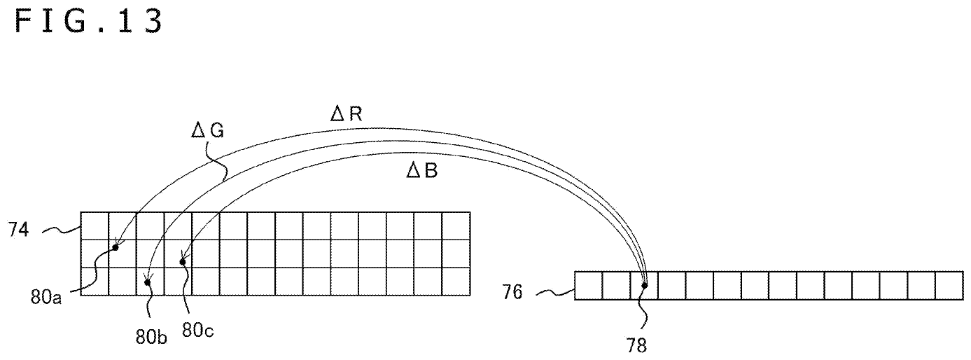

FIG. 13 is a diagram for explaining a pixel value sampling process performed by the head mounted display 100. A left part of the figure schematically depicts a line buffer 74, while a right part schematically depicts a pixel sequence 76 in one line of a display image. In this case, one rectangular shape represents a region of one pixel. In this example, the line buffer 74 stores a pixel sequence in three lines of a distortion image. For determining a pixel value of a pixel 78 included in the pixel sequence 76 of the display image, the difference distortion giving unit 274 initially acquires difference vectors ΔR, ΔG, and ΔB for respective colors associated with the position of this pixel from the distortion information storage unit 276.

Thereafter, the difference distortion giving unit 274 acquires color information associated with positions deviated by the difference vectors from the line buffer 74. Displacement destinations defined by the difference vectors, i.e., sampling positions here are not limited to centers of pixel regions. The figure depicts sampling positions 80a, 80b, and 80c of R, G, and B by way of example. If distortion for G is given to a distortion image stored in the line buffer 74, the sampling position 80b of G is located at the center of the pixel region of the same position on the basis of ΔG=0. Accordingly, the difference distortion giving unit 274 reads a value of G at the sampling position 80b without change, and designates the read value as a pixel value of a G component of the pixel 78 in the display image.

On the other hand, the sampling position 80a of R and the sampling position 80c of B are positions each shifted from the center of a pixel region of another position. In such a case, the difference distortion giving unit 274 calculates an R component and a B component of the sampling positions 80a and 80c by interpolation using an ordinary method such as a nearest neighbor method, a bilinear method, and a bicubic method. In this manner, the pixel value of the pixel 78 in the display image is determined. The display unit 278 sequentially causes light emission from respective lines of the display panel with luminance corresponding to the pixel value thus determined to display a final distortion image.

According to the present embodiment described above, the image display system of the type allowing appreciation of images via the ocular lens performs double-stage inversion correction in accordance with distortion aberration and chromatic aberration of the ocular lens in combination with a drawing process. Specifically, the image display system gives distortion common to R, G, and B during image drawing of a display image and samples a pixel value to give remaining distortion during output to the display panel. In this manner, reduction of a storage region for temporarily storing intermediate data, and reduction of costs for processing including memory access are achievable in comparison with a method which temporarily generates an image having no distortion and gives distortion to the image for each color.

Moreover, processing of the entire system advances in a state of a distortion image. Accordingly, a difference between a target pixel position and a sampling position can be reduced during output to the display panel. In this manner, a necessary storage region prior to display can be saved, and therefore, a memory cost and a load required for a readout process can be reduced. As a result, steps from image drawing to display can be performed with a low delay even in a case of a high-quality image drawing by a method such as ray tracing.

The description of the present invention on the basis of the embodiment has been presented hereinabove. The embodiment is presented only by way of example. It is understood by those skilled in the art that various modifications may be made for combinations of respective constituent elements and respective treating processes of the embodiment and that these modifications are also included in the scope of the present invention.

### REFERENCE SIGNS LIST

100: Head mounted display
150: Control unit
152: Display panel
154: Communication control unit
160: Storage unit
200: Image generating apparatus
222: CPU
224: GPU
226: Main memory
234: Storage unit
236: Output unit
254: Scene data storage unit
256: Distortion information storage unit
260: Input data acquisition unit
261: Viewpoint information acquisition unit
266: Distortion image generating unit
268: Output unit
270: Image data acquisition unit
272: Output data transmission unit
274: Difference distortion giving unit
276: Distortion information storage unit
278: Display unit

### INDUSTRIAL APPLICABILITY

As described above, the present invention is applicable to various types of information processing devices such as an image generating apparatus, a head mounted display, a game device, an image display apparatus, a portable terminal, and a personal computer, image processing systems each including any one of these, and others.

1. An image display system that displays a distortion image generated by giving, to a source image corresponding to a display target, a change opposite to a change produced by aberration of an ocular lens to allow appreciation via the ocular lens, the image display system comprising:
an image generating apparatus that draws a distortion image having common distortion regardless of primary colors; and
a display device that determines pixel values on a basis of sampling results obtained from different positions of the distortion image for each of the primary colors in accordance with chromatic aberration of the ocular lens and outputs the determined pixel values to a display panel, wherein
the display device includes
a buffer memory that temporarily stores data of a predetermined number of lines of the distortion image, and
a sampling unit that samples data stored in the buffer memory, in an order of pixels or pixel sequences to be output to the display panel, to determine the pixel values.

2. (canceled)

3. The image display system according to claim 1, wherein the display device includes a distortion information storage unit that stores information associated with a difference between distortion given by the image generating apparatus to the distortion image and distortion to be given to each of the primary colors in accordance with the chromatic aberration.

4. The image display system according to claim 1, wherein the image generating apparatus includes:
a distortion information storage unit that stores distortion information indicating a correlation between respective pixels in a plane of the distortion image and corresponding positions in a plane of an image having no distortion,
a distortion image generating unit that determines the pixel values of the distortion image by directly obtaining color information associated with the corresponding positions, with reference to the distortion information, and
an output unit that outputs data of the distortion image to the display device in an order of determination of the pixel values.

5. The image display system according to claim 4, wherein the distortion image generating unit draws the distortion image that has distortion corresponding to aberration of one of the primary colors.

6. The image display system according to claim 5, wherein the display device reads a component of the one color at an identical position of the distortion image as a pixel value of the corresponding color and outputs the read component.

7. Ahead mounted display that displays a distortion image generated by giving, to a source image corresponding to a display target, a change opposite to a change produced by aberration of an ocular lens to allow appreciation via the ocular lens, the head mounted display comprising:
an image data acquisition unit that acquires data of a distortion image having common distortion regardless of primary colors;
a buffer memory that temporarily stores data of a predetermined number of lines of the distortion image; and
a display unit that determines pixel values in accordance with chromatic aberration of the ocular lens and in an order of pixels or pixel sequences to be output to a display panel, on a basis of sampling results obtained for each of the primary colors from different positions of the distortion image stored in the buffer memory, and outputs the determined pixel values to the display panel.

8. An image display method for an image display system that displays a distortion image generated by giving, to a source image corresponding to a display target, a change opposite to a change produced by aberration of an ocular lens to allow appreciation via the ocular lens, the image display method comprising:
drawing a distortion image having common distortion regardless of primary colors;
temporarily storing data of a predetermined number of lines of the distortion image in a buffer memory; and
determining pixel values in accordance with chromatic aberration of the ocular lens and in an order of pixels or pixel sequences to be output to a display panel, on a basis of sampling results obtained for each of the primary colors from different positions of the distortion image stored in the buffer memory and outputting the determined pixel values to the display panel.

9. A non-transitory, computer readable storage medium containing a computer program, which when executed by a computer, causes the computer to display a distortion image generated by giving, to a source image corresponding to a display target, a change opposite to a change produced by aberration of an ocular lens to allow appreciation via the ocular lens, by carrying out actions, comprising:
acquiring data of a distortion image having common distortion regardless of primary colors;
temporarily storing data of a predetermined number of lines of the distortion image in a buffer memory; and
determining pixel values in accordance with chromatic aberration of the ocular lens and in an order of pixels or pixel sequences to be output to a display panel, on a basis of sampling results obtained for each of the primary colors from different positions of the distortion image stored in the buffer memory and outputting the determined pixel values to the display panel.
